(19) United States
(12) Patent Application Publication
(10) Pub. No.: US 2011/0067676 A1
(43) Pub. Date: Mar. 24, 2011

(54) METHOD AND APPARATUS FOR CONTROLLING A TANK VENT VALVE

(76) Inventors: Wolfgang Mai, Kronberg (DE); Jens Pache, Helsa (DE)

(21) Appl. No.: 12/990,830

(22) PCT Filed: Apr. 16, 2009
(86) PCT No.: PCT/EP2009/054526

§ 371 Date: Dec. 2, 2010

(30) Foreign Application Priority Data
May 5, 2008 (DE) 102008022079.5

(51) Int. Cl. F02M 25/08

(52) U.S. Cl. 123/518; 137/1

(57) ABSTRACT

In a method for controlling a tank vent valve (28) of a tank vent device (102) for an internal combustion engine (101) of a motor vehicle (100), the tank vent valve (28) is disposed in a vent line (27) between a fuel vapor reservoir (25) and an intake manifold (4) of the internal combustion engine (101). According to the method, the internal combustion engine (101) is switched off, and the tank vent valve (28) is opened when the internal combustion engine (101) has been switched off, if a signal is sensed according to which a start of the internal combustion engine (101) is expected to be imminent.

### CROSS-REFERENCE TO RELATED APPLICATIONS

This application is a U.S. National Stage Application of International Application No. PCT/EP2009/054526 filed Apr. 16, 2009, which designates the United States of America, and claims priority to German Application No. 10 2008 022 079.5 filed May 5, 2008, the contents of which are hereby incorporated by reference in their entirety.

### TECHNICAL FIELD

The invention relates to a method and an apparatus for controlling a tank vent valve of a tank vent device for an internal combustion engine of a motor vehicle.

### BACKGROUND

To comply with predetermined legal emission limit values, modern motor vehicles have a tank vent device. A core piece of the tank vent device is an activated charcoal container, which is connected to the fuel tank by way of a connecting line, in order to adsorb the fuel vapors produced there. The loaded activated charcoal container has to be regenerated from time to time. To this end, the activated charcoal container is connected to the intake tract and/or the intake manifold of the internal combustion engine by way of a vent line and a tank vent valve arranged therein. In operating states in which adequate low pressure prevails in the intake manifold, the tank vent valve is opened, as a result of which the fuel vapors adsorbed in the activated charcoal container are drawn into the intake manifold as regeneration gas. Said fuel vapors mix there with the intake air, enter the combustion chambers of the internal combustion engine and participate there in the combustion. With a fully loaded activated charcoal container, the fuel concentration of the regeneration gas is very high. A suddenly supplied flow of regeneration gas may, in the worst case, result in combustion misfires and a considerable deterioration of the exhaust gas. Therefore, to keep interference of the engine combustion process and deterioration of the exhaust gas composition to a minimum, the introduced flow of regeneration gas must be slowly increased at the start of the tank vent process by means of the tank vent valve. The opening cross-section on the tank vent valve is mostly set in a pre-controlled fashion by means of a pulse width-modulated signal. If the valve is not used for a longer period of time, its opening behavior may change. For instance, on account of adhesion of the valve actuator, this may result in an erratic opening behavior, which results in an unwanted large quantity of regeneration gas discharging into the intake tract of the internal combustion engine. Long idle times in the winter significantly cool down the tank vent valve, thereby possibly resulting in a change in the opening characteristics and in a poorly controllable supply of regeneration gas.

### SUMMARY

According to various embodiments, a method and an apparatus for controlling the tank vent valve can be provided, by means of which the process reliability of the tank vent process can be improved.

According to an embodiment, in a method for controlling a tank vent valve of a tank vent device for an internal combustion engine of a motor vehicle, with the tank vent valve being arranged in a vent line between a fuel vapor reservoir and an intake tract of the internal combustion engine:—the internal combustion engine being switched off,—the tank vent valve being opened when the internal combustion engine is switched off, if a signal is detected which allows an imminent start-up of the internal combustion engine to be surmised.

According to a further embodiment, the tank vent valve may only be opened if a predetermined minimum duration has elapsed since the last switch-off of the internal combustion engine. According to a further embodiment, the tank vent valve can be loaded with current for a predetermined minimum duration. According to a further embodiment, the tank vent valve can be closed again even before the start-up of the internal combustion engine. According to a further embodiment, the tank vent valve can be briefly opened by at least one short current pulse. According to a further embodiment, the signal may represent at least one of the following events:—the activation of the ignition of the internal combustion engine,—the opening of a door of the motor vehicle,—the unlocking of a door closing mechanism of the motor vehicle,—the presence of a person in the passenger compartment of the motor vehicle,—occupation of the driver seat,—insertion of an ignition key into the ignition lock.

According to another embodiment, in a control device for a motor vehicle having an internal combustion engine and a tank vent device, which has a tank vent valve, which is arranged in a vent line between a fuel vapor reservoir and an intake tract of the internal combustion engine, the control device can be embodied such that the tank vent valve is opened when the internal combustion engine is switched off, once a signal was detected which allows an imminent start-up of the internal combustion engine to be surmised.

### BRIEF DESCRIPTION OF THE DRAWINGS

The invention is described in more detail below with the aid of an exemplary embodiment with reference to the appended Figures, in which:

FIG. 1 shows a schematic representation of a motor vehicle having an internal combustion engine and a tank vent device;

FIG. 2 shows a detailed representation of the internal combustion engine and the tank vent device;

FIG. 3 shows an exemplary embodiment of a control method for the tank vent valve in the form of a flow chart.

### DETAILED DESCRIPTION

The control method according to various embodiments relates to a tank vent valve of a tank vent device for an internal combustion engine of a motor vehicle, with the tank vent valve being arranged in a vent line between a fuel vapor reservoir of the tank vent device and an intake tract of the internal combustion engine. According to the method, the internal combustion engine is switched off and the tank vent valve is opened when the internal combustion engine is switched off, if a signal is detected which allows an imminent start-up of the internal combustion engine to be surmised.

After switching off the internal combustion engine, ambient pressure generally appears in the whole intake tract after a brief period of time. According to various embodiments, deviations in the opening behavior and/or in the opening characteristic curve of the tank vent valve after a long period of inactivation can be eliminated or at least mitigated, if the tank vent valve is opened at least briefly, as promptly as possible before a start-up of the internal combustion engine. As ambient pressure prevails in the intake tract and/or in the intake manifold, no or only very small quantities of regeneration gas flow into the intake tract. In this way, an adhered tank vent valve can be released for instance by actuating the valve actuator, with, for the afore-cited reasons, the sudden opening behavior not having any disadvantages when the internal combustion engine is idle. This preconditioning of the tank vent valve when the internal combustion engine is idle enables a significantly improved controllability and dosability of the regeneration gas flow and therefore improves the process reliability of a subsequent tank vent process during operation of the internal combustion engine.

According to an embodiment of the method, the tank vent valve is then only opened if a predetermined minimum period of time has elapsed since the internal combustion engine was last switched off.

This herewith ensures that a pressure equalization has taken place between the ambient area and the intake tract, so that ambient pressure also prevails in the intake tract. It is possible to largely prevent electric power vapors from reaching the intake tract when the tank vent valve is opened. At the same time, the tank vent device can cool down, as a result of which the pressure in the tank vent device is reduced. As a result, the risk of an inflow of fuel vapors when the tank vent valve is opened is prevented or at least significantly reduced.

In a further embodiment of the method, current is applied to the tank vent valve for a predetermined minimum period of time.

The long-term current feed of the tank vent valve preheats the actuator. This is advantageous particularly in the case of low external temperatures and longer idle times of the motor vehicle, since very low temperatures change the opening behavior and/or the opening characteristic curve of the tank vent valve. With a subsequent tank vent process during operation of the internal combustion engine, a more precise control of the tank vent valve and thus an improved dosing of the regeneration gas flow can therefore be achieved.

In one embodiment of the method, the tank vent valve is closed again even before the start-up of the internal combustion engine.

Upon start-up of the internal combustion engine, air is taken in from the intake tract into the combustion chambers by moving the pistons, as a result of which the pressure in the intake manifold drops. To prevent fuel vapors from flowing into the intake manifold via an opened tank vent valve, this is closed before the start-up. As a result, negative effects on the combustion mixture composition and the exhaust gas composition can be reliably prevented.

In a further embodiment of the method, the tank vent valve is only opened briefly.

In particular, with high external temperatures and a brief downtime of the internal combustion engine, the tendency of the fuel to evaporate and thus the pressure in the tank vent device is great. As a result of the only very brief opening of the tank vent valve, a reliable release and/or preconditioning of the tank vent valve is achieved on the one hand and at the same time it is prevented that relevant quantities of regeneration gas enter the intake tract.

In one embodiment, the signal represents at least one of the following events: the activation of the ignition of the internal combustion engine, the opening of a door of the motor vehicle, the unlocking of a door closing mechanism of the motor vehicle, the presence of a person in the passenger compartment of the motor vehicle, the occupation of the driver seat or the insertion of the ignition key into the ignition lock.

These signals allow for a very probable prediction of an imminent start-up of the internal combustion.

A control device can be embodied such that it can embody the method as described above. To this end, corresponding control functions are implemented in the control device using software. In respect of the advantages which result from this control device, reference is made to the embodiments relating to the method.

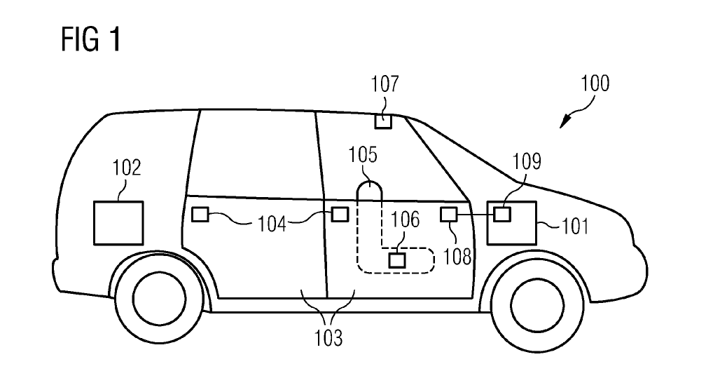

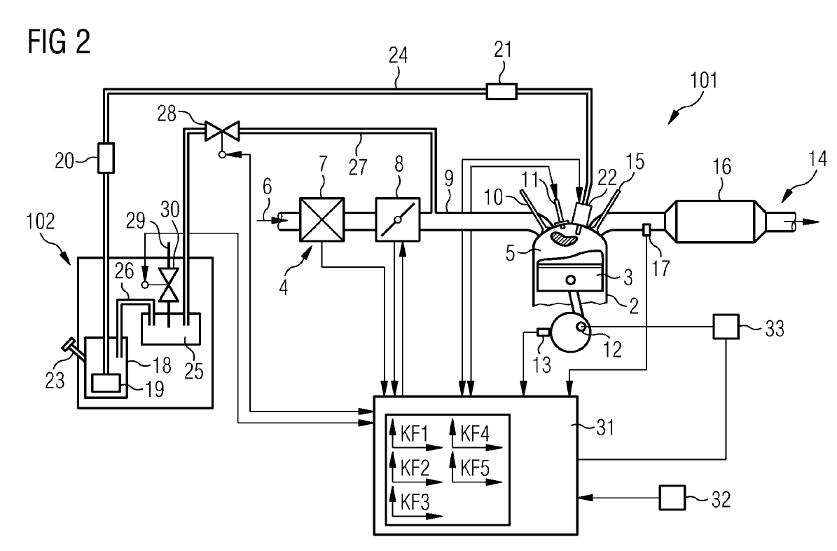

FIG. 1 shows a schematic representation of a motor vehicle 100. The motor vehicle 100 is powered by an internal combustion engine 101 and has a tank vent device 102. Details and the interaction of the internal combustion engine 101 and the tank vent device 102 are explained in more detail with reference to FIG. 2. The motor vehicle 100 has several doors 103, by way of which a person (not shown), for instance the motor vehicle driver or a passenger, can enter the motor vehicle 100. The doors 103 each include a door closing mechanism 104, which can be immediately actuated manually by a person or by way of a wireless remote control. Each door closing mechanism 104 comprises a suitable door sensor, by means of which the opening and unlocking of the door 103 can be detected.

Seats 105 for the passengers are arranged in the motor vehicle 100 (only one seat is shown in FIG. 1). A seat sensor 106 is integrated into each seat 105, said seat sensor detecting if a person takes a seat on said seat 105. A passenger compartment sensor 107 is attached in the passenger compartment of the motor vehicle 100, said passenger compartment sensor detecting the presence or the entrance of a person into the passenger compartment.

The motor vehicle 100 also has an ignition lock 108, by way of which the motor vehicle driver can activate the ignition and a start-up mechanism 109 of the internal combustion engine 101 by inserting an ignition key (not shown). The ignition lock 108 also has a corresponding ignition lock sensor, which detects the insertion of the ignition key and/or the activation of the ignition.

All the afore-cited sensors are connected to a control device (see FIG. 2) assigned to the internal combustion engine 101 by way of data/signal lines, so that the sensor signals and information from the control device 31 (see FIG. 2) are available.

FIG. 2 shows a schematic representation of the internal combustion engine 101 and the tank vent device 102. The internal combustion engine 101 comprises at least one cylinder 2 and a piston 3 which can be moved up and down in the cylinder 2. The fresh air needed for the combustion is introduced into a combustion chamber 5 delimited by the cylinder 2 and the piston 3 by way of an intake tract 4. An air mass sensor 7 for detecting the air flow in the intake tract 4, which is seen as a measure of the load of the internal combustion engine 1, is disposed in the intake tract 4 downstream of an intake opening 6, as too is a throttle valve 8 for controlling the air flow, an intake manifold 9 and an inlet valve 10, by means of which the combustion chamber 5 is optionally connected to the intake tract 4 or is separated therefrom.

The combustion is triggered by means of an ignition plug 11. The drive energy generated by the combustion is transmitted to the drive train of the motor vehicle (not shown) by way of a crankshaft 12. A speed sensor 13 detects the speed of the internal combustion engine 1. The internal combustion engine 101 also includes an electrical starter device 33, by means of which the internal combustion engine can be started.

The combustion exhaust gases are discharged via an exhaust gas tract 14 of the internal combustion engine 1. The combustion chamber 5 is optionally connected to the exhaust gas tract 14 or separated therefrom by means of an outlet valve 15. The exhaust gases are purified in an emission control catalyst 16. A so-called lambda sensor 17 for measuring the oxygen content in the exhaust gas is also found in the exhaust gas tract 14.

The internal combustion engine 1 also comprises a fuel supply facility having a fuel tank 18, a fuel pump 19, a high pressure pump 20, a fuel accumulator 21 and at least one controllable injection valve 22. The fuel tank 18 has a closeable filling piece 23 for filling fuel. The fuel is conveyed into a fuel supply line 24 by means of the fuel pump 19. The high pressure pump 20 and the pressure accumulator 21 are arranged in the fuel supply line 24. The high pressure pump 20 has the task of feeding high-pressure fuel to the pressure accumulator 21. The pressure accumulator 21 is embodied here as a shared pressure accumulator 21 for all injection valves 22. All injection valves 22 are supplied with pressurized fuel therefrom. The exemplary embodiment is an internal combustion engine 1 having direct fuel injection, in which the fuel is directly injected into the combustion chamber 5 by means of an injection valve 22 protruding into the combustion chamber 5. Reference is however made to the present invention not being restricted to this type of fuel injection but also being useable with other types of fuel injection, like for instance intake manifold injection.

A fuel vapor reservoir 25, which is embodied as an activated charcoal container for instance, belongs to the tank vent device 102 and is connected to the fuel tank 18 by way of a connecting line 26. The fuel vapors produced in the fuel tank 18 are routed into the fuel vapor reservoir 25 and are adsorbed there by the activated charcoal. The fuel vapor reservoir 25 is connected to the intake manifold 9 of the internal combustion engine 1 by way of a vent line 27. A controllable tank vent valve 28 is located in the vent line 27. Furthermore, fresh air can be fed to the fuel vapor reservoir 25 by way of a vent line 29 and a controllable vent valve 30 arranged optionally therein. In certain operating ranges of the internal combustion engine 1, in particular during idling or partial load, a large pressure drop prevails between the ambient area and the intake manifold 9 as a result of the strong throttle effect by the throttle valve 8. Opening the tank vent valve 28 and the vent valve 30 therefore results in a flushing effect during a tank vent period, whereby the fuel vapors stored in the fuel vapor reservoir 25 are routed into the intake manifold 9 and participate in the combustion. The fuel vapors thus bring about a change in the composition of the combustion gases and the exhaust gases.

A control device 31 is assigned to the internal combustion engine, in which control device 31 engine control functions (KR1-KF5) based on engine characteristics are implemented using software. The control device 31 is connected to all actuators and sensors of the internal combustion engine 1 by way of signal and data lines. In particular, the control device 31 is connected to the controllable vent valve 30, the controllable tank vent valve 28, the air mass sensor 7, the controllable throttle valve 8, the controllable injection valve 22, the spark plug 11, the lambda sensor 17, the speed sensor 13 and an ambient temperature sensor 32 in order to measure the ambient temperature. As was already mentioned with respect to FIG. 1, the control device 31 is connected to the door sensor, the seat sensor 106, the passenger compartment sensor 107, the ignition lock sensor and the starter device 33.

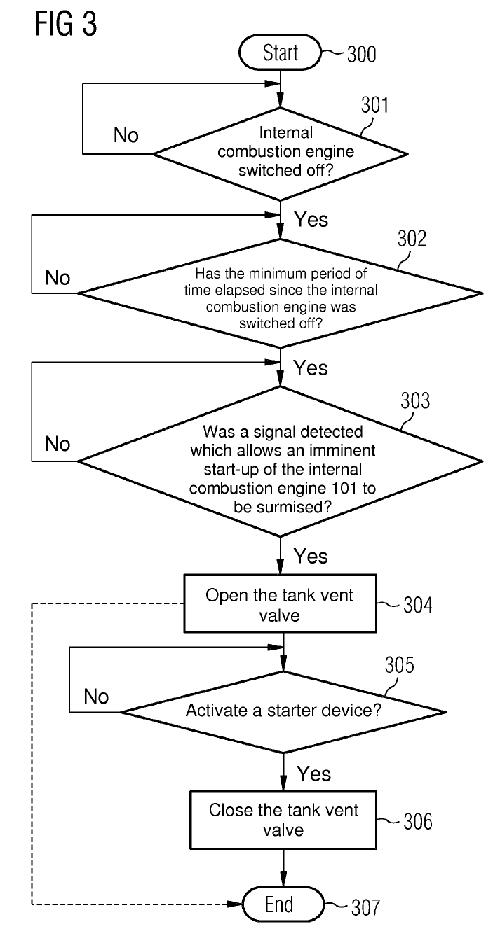

FIG. 3 shows an exemplary embodiment of a method for controlling a tank vent valve 28 in the form of a flow chart. The method is started with step 300, for instance when starting up the internal combustion engine 101.

During operation of the internal combustion engine 101, a check is carried out in step 301 to determine whether the internal combustion engine is switched off. With a negative result of the query, this is repeated. With a positive result, the method continues with step 302 and a timer implemented in the control device 31 is started.

Step 302 queries whether a minimum duration has elapsed since the internal combustion engine 101 was switched off. This can take place for instance in that the value of the timer is compared with a predetermined value for the minimum duration. If the minimum duration has still not elapsed, in other words the value of the timer is still smaller than the value of the minimum duration, the query is repeated. If it is however determined that the minimum duration has elapsed, the method continues with step 303. The delay in the further method steps by this minimum duration originates for instance in that the temperature and the pressure in the tank vent device 102 are to drop. In particular, after long driving times, an increased temperature and thereby a higher pressure prevail in the tank vent device 102, since the fuel has an increased tendency to release gas. Waiting the minimum duration ensures that the tank vent device 102 can cool down and the pressure in the tank vent device 102 thus reduces. As becomes clear during the course of the further description, it should herewith be prevented that larger quantities of fuel vapors are unintentionally routed into the atmosphere.

Step 303 checks whether a signal was detected which allows an imminent start-up of the internal combustion engine 101 to be surmised. To this end, the output signals of the sensors of the motor vehicle 100 described in respect of FIG. 1 are monitored. The insertion of the ignition key into the ignition lock and/or the activation of the ignition of the internal combustion engine 101 is recognized by the ignition lock sensor and this is sent to the control device 31 as a signal. Furthermore, the opening of the door of the motor vehicle 100 and/or the unlocking of the door closing mechanism 104 is also detected by means of the door sensor. This information is also routed to the control device 31 as a signal. Furthermore, the passenger compartment sensor 107 recognizes the presence of a person in the passenger compartment of a motor vehicle 100 and the seat sensor 106 recognizes the occupation of the driver seat 105. The control device 31 also receives corresponding signals from these sensors.

The signals of the sensors listed here provide evidence that a person, who may be the motor vehicle driver for instance, enters the passenger compartment of the motor vehicle 100 and/or takes a seat on the driver seat 105 and/or wants to activate the ignition of the internal combustion engine 101 using the ignition key. All these events allow conclusions to be drawn, with a certain probability, that the internal combustion engine 101 will be started up in the near future. The sensors described here and the signals thereof are however not a conclusive list and only have an exemplary character. Other sensors and their signals can also be used provided they refer to an imminent start-up of the internal combustion engine with a certain probability. With a negative result of the query in step 303, this query is repeated. With a positive result, the method continues with step 304.

In step 304, the tank vent valve 28 is activated by the control device 31 such that it opens the same. The opening of the tank vent valve 28 may only be a brief opening by briefly powering the electromagnetic actuator of the tank vent valve 28. This brief opening of the tank vent valve 28 effects a release of the actuator if this is fixed thereto. Adhesion of the actuator may take place for instance after longer idle times of the internal combustion engine 101 and/or longer inactivation of the tank vent valve 28, for instance by contamination. On the other hand, the only brief opening of the tank vent valve 28 can largely minimize the risk of the escape of fuel vapors. This means that even if a pressure prevails in the tank vent device 102, which is greater than the ambient pressure, only very small quantities of fuel vapors escape into the atmosphere. With an only very brief opening of the tank vent valve 28, the method according to step 304 can be terminated in step 307 (this is shown in FIG. 3 by the dashed arrow).

Alternatively, the tank vent valve 28 can also be opened and closed consecutively a number of times or opened for a longer period of time by a corresponding continuous current feed. In addition to releasing the actuator, this procedure is also advantageous, particularly in the case of low temperatures, in that the tank vent valve 28 is preheated toward the operating temperature and/or the reference temperature, for which the opening characteristic curves are stored in the control device 31. Deviations of the opening behavior from the reference opening characteristic curve and thus control inaccuracies can be compensated in this way.

If the tank vent valve 28 is opened and closed consecutively a number of times or opened for longer periods, the method according to step 304 continues with step 305, whereby a check is carried out to determine whether the starter device 33 of the internal combustion engine 101 was activated. This may take place in that the signal from a starting motor or the actuation of a starter button is identified in the passenger compartment. With a negative result of the query, this is repeated. With a positive result of the query in step 305, the method continues with step 306, in which the tank vent valve 28 is still closed prior to initiating the starting process of the internal combustion engine 101, in other words, before rotating the crankshaft. The reason for closing the tank vent valve 28 consists in an intake effect occurring as a result of the rotation of the crankshaft 12 and/or as a result of the initiation of the start-up process by the piston 3 which can be moved up and down, by means of which intake effect the air in the intake manifold 9 is drawn into the combustion chambers and thus results in an evacuation of the intake manifold 9. Therefore, to prevent fuel vapors from escaping via the tank vent valve 28 via the intake manifold 9, this is closed beforehand. The method can subsequently be terminated with step 307.

The described method is advantageous in that the tank vent valve 28 can be preconditioned very promptly before a start-up of the internal combustion engine 101. This means that a possibly adhered or firmly attached actuator of the tank vent valve 28 is released, so that an uncontrolled and erratic opening behavior can be prevented with a subsequently implemented tank vent process. Furthermore, the tank vent valve 28 can be brought to operating temperature by a correspondingly longer current feed, so that deviations in the opening behavior from the reference opening characteristic curve and thus associated inaccuracies in the control can be avoided. The method is implemented while the internal combustion engine 101 is still idle, with almost ambient pressure prevailing in the intake manifold 9, in other words at the position of the tank vent valve 28 in the intake tract 4. Therefore an escape of fuel vapors when opening the tank vent valve 28 can be almost completely prevented.

What is claimed is:

1. A method for controlling a tank vent valve of a tank vent device for an internal combustion engine of a motor vehicle, with the tank vent valve being arranged in a vent line between a fuel vapor reservoir and an intake tract of the internal combustion engine, the method comprising:
switching off the internal combustion engine,
opening the tank vent valve when the internal combustion engine is switched off, if a signal is detected which allows an imminent start-up of the internal combustion engine to be surmised.

2. The method according to claim 1, wherein the tank vent valve is only then opened if a predetermined minimum duration has elapsed since the last switch-off of the internal combustion engine.

3. The method according to claim 1, wherein the tank vent valve is loaded with current for a predetermined minimum duration.

4. The method according to claim 1, wherein the tank vent valve is closed again even before the start-up of the internal combustion engine.

5. The method according to claim 1, wherein the tank vent valve is briefly opened by at least one short current pulse.

6. The method according to claim 1, wherein the signal represents at least one of the following events:
the activation of the ignition of the internal combustion engine,
the opening of a door of the motor vehicle,
the unlocking of a door closing mechanism of the motor vehicle,
the presence of a person in the passenger compartment of the motor vehicle,
occupation of the driver seat,
insertion of an ignition key into the ignition lock.

7. A control device for a motor vehicle having an internal combustion engine and a tank vent device, which has a tank vent valve, which is arranged in a vent line between a fuel vapor reservoir and an intake tract of the internal combustion engine, wherein the control device is operable to open the tank vent valve when the internal combustion engine is switched off, if a signal was detected which allows an imminent start-up of the internal combustion engine to be surmised.

8. The device according to claim 1, wherein the device is further operable to only open the tank vent valve if a predetermined minimum duration has elapsed since the last switch-off of the internal combustion engine.

9. The device according to claim 8, wherein the device comprises a timer to determine if a predetermined minimum duration has elapsed since the last switch-off of the internal combustion engine.

10. The device according to claim 1, wherein the device is further operable to load the tank vent valve with current for a predetermined minimum duration.

11. The device according to claim 1, wherein the device is further operable to close the tank vent valve again even before the start-up of the internal combustion engine.

12. The device according to claim 1, wherein the device is further operable to briefly open the tank vent valve by at least one short current pulse.

13. The device according to claim 1, wherein the signal representing at least one of the following events:
the activation of the ignition of the internal combustion engine,
the opening of a door of the motor vehicle,
the unlocking of a door closing mechanism of the motor vehicle,
the presence of a person in the passenger compartment of the motor vehicle,
occupation of the driver seat,
insertion of an ignition key into the ignition lock.

14. A method for controlling a tank vent valve of a tank vent device for an internal combustion engine of a motor vehicle, with the tank vent valve being arranged in a vent line between a fuel vapor reservoir and an intake tract of the internal combustion engine, the method comprising:
checking whether the internal combustion engine is switched off, and
if the internal combustion engine is switched off:
opening the tank vent valve if a signal is detected which allows an imminent start-up of the internal combustion engine to be surmised.

15. The method as claimed in claim 14, wherein the tank vent valve is only opened if a predetermined minimum duration has elapsed since the last switch-off of the internal combustion engine.

16. The method as claimed in claim 14, further comprising the step of starting a timer if the internal combustion engine is switched off, and only opening the tank vent valve if a predetermined minimum duration determined by said timer has elapsed since the last switch-off of the internal combustion engine.

17. The method as claimed in claim 14, wherein the tank vent valve is loaded with current for a predetermined minimum duration.

18. The method as claimed in claim 14, wherein the tank vent valve is closed again even before the start-up of the internal combustion engine.

19. The method as claimed in claim 14, wherein the tank vent valve is briefly opened by at least one short current pulse.

20. The method as claimed in claim 14, wherein the signal represents at least one of the following events:
the activation of the ignition of the internal combustion engine,
the opening of a door of the motor vehicle, the unlocking of a door closing mechanism of the motor vehicle,
the presence of a person in the passenger compartment of the motor vehicle,
occupation of the driver seat,
insertion of an ignition key into the ignition lock.
